(19) United States
(12) Patent Application Publication
(10) Pub. No.: US 2020/0156733 A1
(43) Pub. Date: May 21, 2020

(54) Articulating Wheeled Vehicle

(71) Applicants: Mara Spector, Beverly Hills, CA (US); Tom Dreifus, Beverly Hills, CA (US)

(72) Inventors: Mara Spector, Beverly Hills, CA (US); Tom Dreifus, Beverly Hills, CA (US)

(21) Appl. No.: 16/458,653

(22) Filed: Jul. 1, 2019

Related U.S. Application Data
(60) Provisional application No. 62/692,218, filed on Jun. 29, 2018.

(51) Int. Cl. B62K 27/12; B60D 1/00

(52) U.S. Cl. CPC B62K 27/12; B60D 2001/003; B60D 1/00

(57) ABSTRACT

A wheeled vehicle includes: a front portion having a central support frame, a front wheel pivotally mounted on a front end of the support frame for steering the wheeled vehicle, a first axle mounted on a rear end of the support frame, the first axle including a first pair of wheels mounted thereon, and a multi-axis pivot mounted on the central support frame adjacent the first axle, the multi-axis pivot including a receiver; a rear portion having a frame portion and a second axle on a rear end thereof. The second portion is secured on the multi-axis pivot of the front portion at a front end of the rear portion.

### CROSS-REFERENCE TO RELATED APPLICATION

This application claims priority to and is a non-provisional of U.S. Patent Application Ser. No. 62/692,218 for a “Five-wheeled Vehicle” filed on Jun. 29, 2018, the contents of which are incorporated herein by reference in its entirety.

### FIELD

This disclosure relates to the field of wheeled vehicles. More particularly, this disclosure relates to a combined three-wheeled cycle vehicle and carriage articulately attached thereto.

### BACKGROUND

Horse-drawn chariots and carriages have long been in existence and used for a variety of purposes. More recently, horse drawn carriages are used for special events such as weddings and tours. While horse-drawn chariots provide unique transportation for special events, difficulties of operating a horse-drawn carriage exist including obtaining a horse or other animal for pulling the carriage.

It is desirable to use a powered vehicle for towing a carriage given the simplicity of a vehicle relative to a horse and other advantages. Attempts have been made to pull specially constructed carriages for special occasions. However, those attempts typically result from modified existing vehicles and may not provide for stable vehicles or for vehicles that are attractive in appearance. For example, modifying an existing vehicle for towing a carriage typically requires modification of the vehicle and further requires operation of the vehicle in conditions for which the vehicle was not intended. This makes operation of the vehicle not only unsafe, but also provides an appearance that is undesirable for special occasions.

What is needed, therefore, is a wheeled vehicle for simulating a horse-drawn carriage while being stable to operate.

### SUMMARY

The above and other needs are met by a wheeled vehicle having a front portion and rear portion forming a vehicle with the appearance of a carriage. In a first aspect, a wheeled vehicle includes: a front portion having a central support frame, a front wheel pivotally mounted on a front end of the support frame for steering the wheeled vehicle, a first axle mounted on a rear end of the support frame, the first axle including a first pair of wheels mounted thereon, and a multi-axis pivot mounted on the central support frame adjacent the first axle, the multi-axis pivot including a receiver; a rear portion having a frame portion and a second axle on a rear end thereof. The second portion is secured on the multi-axis pivot of the front portion at a front end of the rear portion.

In one embodiment, the front portion having the front wheel and first pair of wheels forms a tricycle. In another embodiment, the wheeled vehicle further includes a handlebar secured to the front wheel for turning the front wheel of the vehicle to steer the vehicle. In yet another embodiment, the rear portion includes a pair of opposing benches for supporting a plurality of passengers on the rear portion of the wheeled vehicle.

In one embodiment, the pivot includes a lower plate mounted on the support structure of the front portion, a center block pivotally attached to the lower plate along a first axis, and an upper plate mounted on the center block along a second axis.

In another embodiment, the rear portion is affixed to the pivot of the front portion with one or more fasteners. In yet another embodiment, the rear portion is removably mounted on the pivot of the front portion.

In one embodiment, the pivot is located on the support structure of the front portion ahead of the first axle. In another embodiment, the first axle is in communication with a motor for powering the wheeled vehicle.

In a second aspect, a wheeled vehicle includes: a front portion having a central support frame, a front wheel pivotally mounted on a front end of the support frame for steering the wheeled vehicle, a first axle mounted on a rear end of the support frame, the first axle including a first pair of wheels mounted thereon, and a multi-axis pivot mounted on the central support frame adjacent to and in front of the first axle, the multi-axis pivot including a receiver; a rear portion having a frame portion and a second axle on a rear end thereof, wherein the second portion is secured on the multi-axis pivot of the front portion at a front end of the rear portion. A weight of the rear portion supported on the front portion of the wheeled vehicle is ahead of the first axle of the wheeled vehicle.

In one embodiment, the front portion having the front wheel and first pair of wheels forms a tricycle. In another embodiment, the wheeled vehicle further includes a handlebar secured to the front wheel for turning the front wheel of the vehicle to steer the vehicle. In yet another embodiment, the rear portion includes a pair of opposing benches for supporting a plurality of passengers on the rear portion of the wheeled vehicle.

In one embodiment, the pivot includes a lower plate mounted on the support structure of the front portion, a center block pivotally attached to the lower plate along a first axis, and an upper plate mounted on the center block along a second axis. In another embodiment, the rear portion is affixed to the pivot of the front portion with one or more fasteners. In yet another embodiment, the rear portion is removably mounted on the pivot of the front portion. In one embodiment, the first axle is in communication with a motor for powering the wheeled vehicle.

In a third aspect, a wheeled vehicle includes: a front portion having a central support frame, a front wheel pivotally mounted on a front end of the support frame for steering the wheeled vehicle, a first axle mounted on a rear end of the support frame, the first axle including a first pair of wheels mounted thereon, and a multi-axis pivot mounted on the central support frame adjacent the first axle, the multi-axis pivot including a receiver, the multi-axis pivot having a lower plate mounted on the support structure of the front portion, a center block pivotally attached to the lower plate along a first axis, and an upper plate mounted on the center block along a second axis; a rear portion having a frame portion and a second axle on a rear end thereof. The second portion is secured on the multi-axis pivot of the front portion at a front end of the rear portion.

In one embodiment, the pivot is located on the support structure of the front portion ahead of the first axle. In another embodiment, the first axle is in communication with a motor for powering the wheeled vehicle.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1 and 2 show perspective views of a wheeled vehicle according to one embodiment of the present disclosure;

FIG. 3 shows a top down view of a wheeled vehicle during turning of the vehicle according to one embodiment of the present disclosure;

FIG. 4 shows a top down view of a wheeled vehicle according to one embodiment of the present disclosure;

FIG. 5 shows a side view of a wheeled vehicle according to one embodiment of the present disclosure;

FIG. 6 shows a front view of a wheeled vehicle according to one embodiment of the present disclosure;

FIG. 7 shows a rear view of a wheeled vehicle according to one embodiment of the present disclosure; and

FIG. 8 shows a close-up view of a pivot of a wheeled vehicle according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

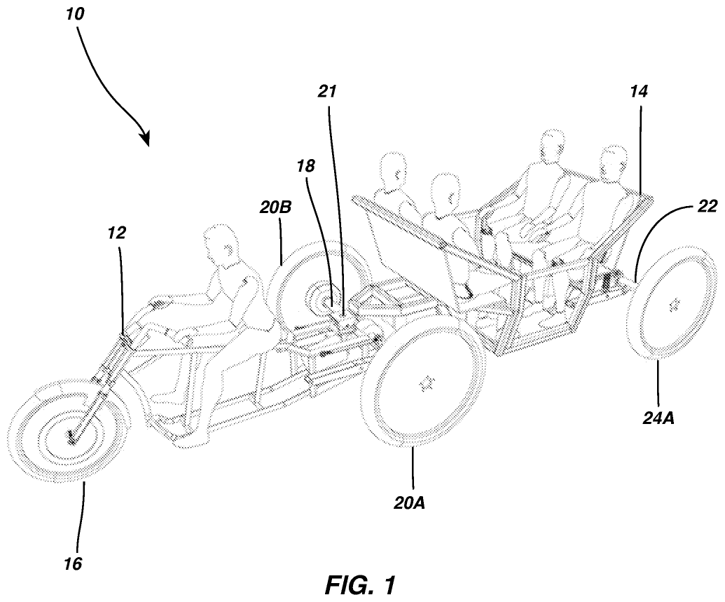

A wheeled vehicle 10 (FIG. 1) is disclosed to improve and make a more efficient, safe and modern way to drive a carriage style vehicle on public roads replacing traditional horse drawn carriage solutions. In some embodiments, the wheeled 10 is a low speed electric motor vehicle that replaces a horse with a tricycle style motorcycle (a front section) 12 and a carriage (a rear section) 14 combined. The motorcycle 12 forms a front portion of the wheeled vehicle 10 while the carriage 14 forms a rear portion of the wheeled vehicle 10. In one embodiment, the wheeled vehicle 10 has one front turning wheel 16 connected to an articulating frame/chassis with an additional two axles. A first axle 18 having two wheels 20A and 20B is adjacent a frame pivot 21 and a second axle 22 having two wheels 24A and 24B is located behind the frame pivot 21. The front turning wheel 16 is aligned with a centerline of the wheeled vehicle 10 and initiates the first axle 18 with two wheels to pivot in relation to the second axle 22. The wheeled vehicle 10 is designed to have a rider/driver on the front portion of the frame/chassis and a number of passengers on transported on the rear part frame/chassis of the vehicle.

Embodiments of the wheeled vehicle 10 are intended to operate as one complete vehicle wherein turning of the wheeled vehicle 10 is dependent on the frame pivot 21 located at a center of the wheeled vehicle 10. The frame pivot 21 preferably permanently fixes front and rear sections of the wheeled vehicle 10 together. The frame pivot 21 further preferably also allows flexibility between the front and rear sections of the wheeled vehicle 10 and allows free rotation of the front section relative to the rear section along three axes. Rotation along a z-axis allows the wheeled vehicle 10 to make turns in right and left directions. Rotation from side to side along a y axis allows for camber changes between front and rear sections of the wheeled vehicle 10 on uneven pavement. Pivotal movement along an x axis is further desired to accommodate pitch changes along the length of the wheeled vehicle 10 such as driveways and ramps.

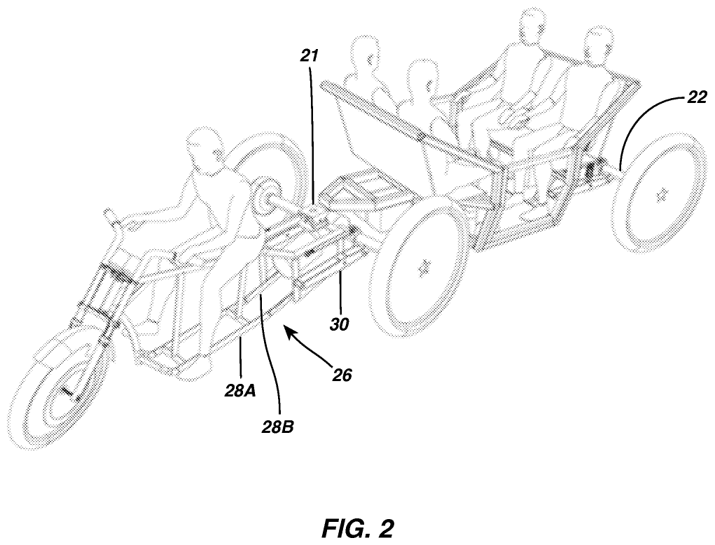

Referring to FIG. 2, a chassis of the wheeled vehicle 10 preferably includes a centrally located support structure 26 on which the main pivot mechanism is mounted. The center-mounted support structure includes of two parallel rails 28A and 28B located slightly off center in the package, allowing the majority of the vehicles weight to be carried on these rails. The rails 28A and 28B are uniquely placed so that the majority of the weight can be mounted between the rails 28A and 28B and such that one or more suspension linkages 30 can be mounted directly to an outside of the rails 28A and 28B, thereby simplifying an overall structure of the vehicle 10. This allows the main vehicle weight, batteries, to be mounted between the rails 28A and 28B and low in the vehicle 10 and in the center for lateral stability as well as even weight distribution. One battery pack located near the front axle and the other near the rear axle allowing for balanced weight distribution, thereby improving safety and handling characteristics. Should the vehicle 10 not be electric with a battery power source but instead include an internal combustion engine, arrangement of the internal combustion engine is also preferably between the two parallel rails 28A and 28B. A fuel tank and other important components can be packaged in this safe protected space between the frame rails.

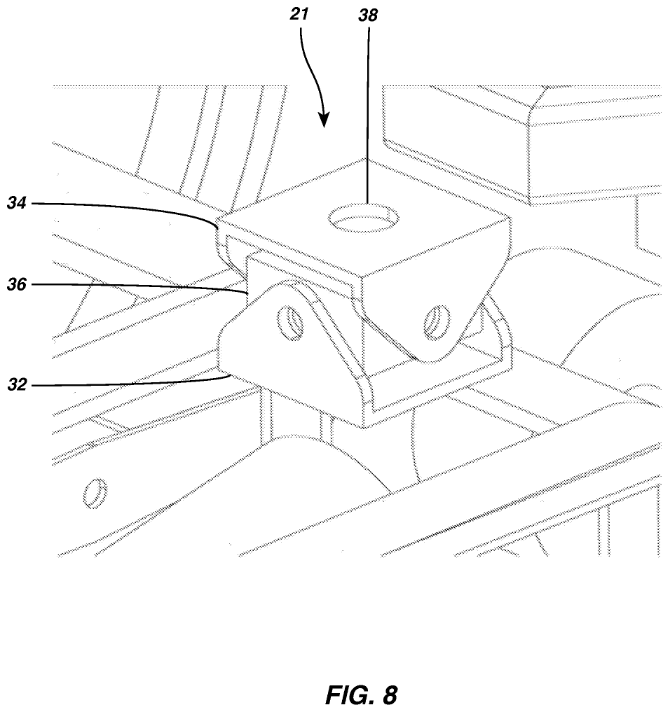

FIG. 8 shows a close-up view of the pivot 21 of the vehicle 10 according to one embodiment of the present disclosure. The pivot 21 is preferably mounted on the support structure 26 of the vehicle 10, such as between the two parallel rails 28A and 28B (FIGS. 1 and 2). The pivot 21 includes a lower plate 32 and an upper plate 34. A center block 36 is located between the lower plate 32 and the upper plate 34. The lower plate 32 is fixed to the front portion of the vehicle 10. The center block 36 is pivotally attached to the lower plate 32 along a first axis. The upper plate 34 is pivotally attached to the center block 36 along a second axis, the second axis preferably being perpendicular to an orientation of the first axis. The upper plate 36 includes a receiver portion 38 formed thereon for receiving at least a portion of the rear portion of the vehicle 10. The rear portion of the vehicle is preferably pivotally secured to the pivot 21 on the upper plate 34. Attachment of the rear portion of the vehicle 10 may be fixed, such as with one or more fasteners. Alternatively, the rear portion of the vehicle 10 may be removably secured to the pivot 21 such that the rear portion of the vehicle 10 may be removably secured to the front portion of the vehicle 10.

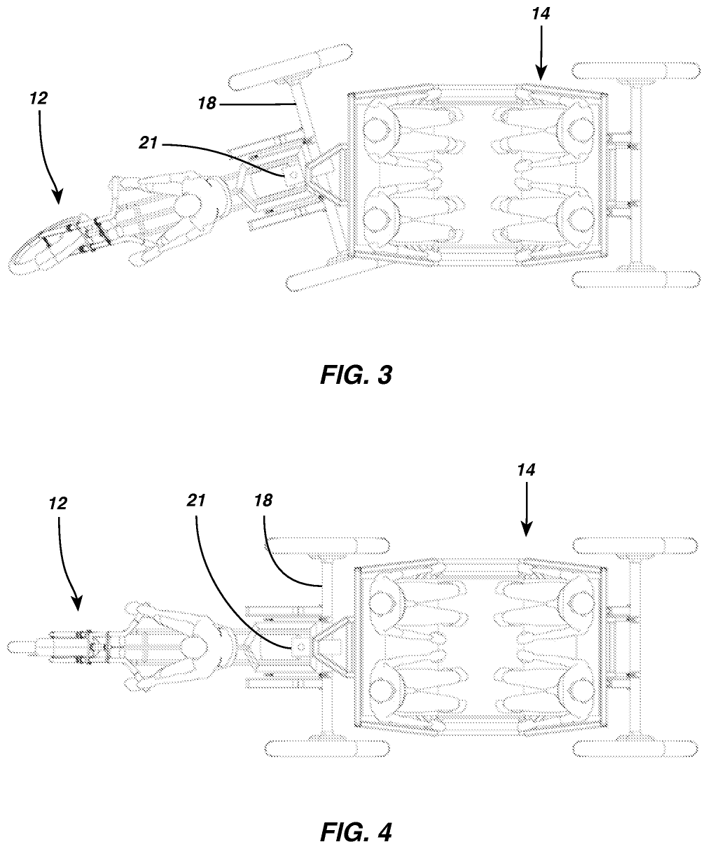

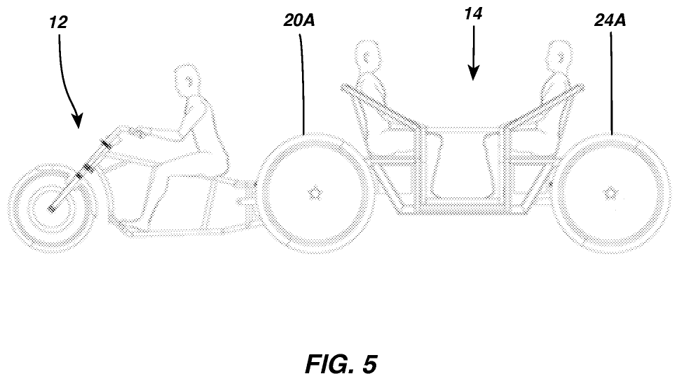

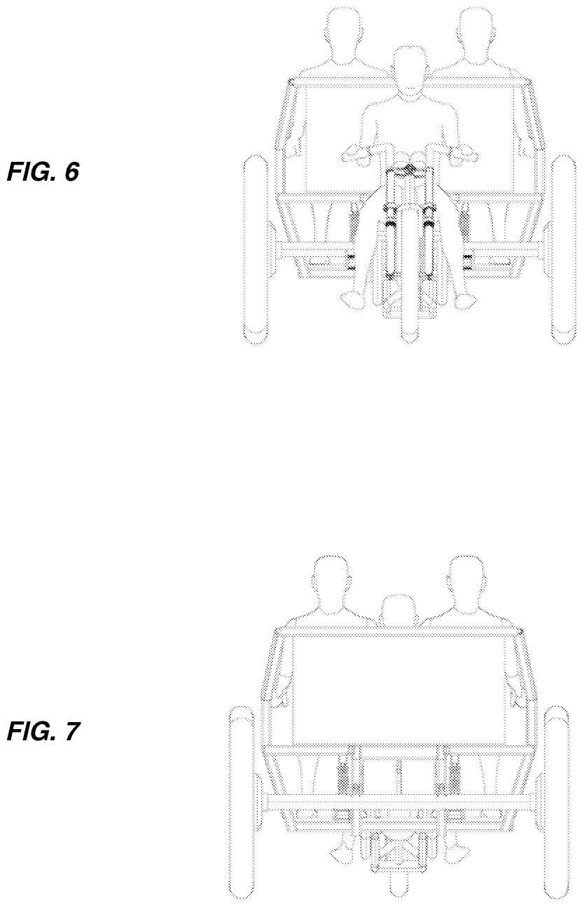

As shown in FIGS. 1-4, the pivot 21 is preferably mounted on the support structure 26 ahead of the first axle 18 of the vehicle 10. When the rear portion 14 is secured on the pivot 21, a weight of the rear portion 14 placed on the front portion 12 of the vehicle 10 is located ahead of the first axle 18 such that handling of the vehicle 10 is improved. When the front portion 12 is turned, as shown in FIG. 3, the pivot 21 allows the front portion 12 to pivot with respect to the rear portion 14 for turning of the vehicle 10. Further, and as shown in FIG. 5, when the rear portion 14 is secured to the front portion 12, the vehicle 10 gives the appearance of the rear portion 14 being a 4-wheeled carriage or other similar vehicle rather than the appearance of a distinctive tow vehicle and trailer.

A layout of the vehicle 10 allows for many different configurations. The rear portion of the vehicle can be arranged to carry 2, 4, and 6 passengers in various seating configurations. A driver of the vehicle will be located in the front half of the vehicle with windshield coverage. The vehicle 10 is preferably equipped with safety seat belts for all passengers and driver.

Easy ingress and egress with a low floor and minimum step over height. Passengers can uniquely sit facing each other for conversation and sightseeing, this seating layout allows for increase leg room for passengers in an efficient overall size. The compact size allows for a lighter vehicle helping to meet a 3000 lb GVW weight target.

The unique configuration of a five wheeled vehicle and its driving dynamics, the front wheel initiates the turn and the middle set of wheels work to complete the turn.

Embodiment 1: A middle set of wheels are mounted to a second axle and are rigidly connected to a front part of the frame. When the frame turns the second set of wheels rotated around a pivot mounted on that frame which completes the vehicles turn. This axle must have a differential to allow for independent wheel movement or one free wheel and one drive wheel.

Embodiment 2: The middle sets of wheels are mounted to the second solid axle with pivots on either ends, these pivots are attached to a steering bar that connects to the front frame. As the front frame rotates it moves a steering bar from right to left which in turn turns the front wheels independently of the frame this also allows it to have Ackerman steering.

Embodiment 1: For solid vehicle dynamics and to eliminate a push condition an engine or motor power source is attached to the front frame in front of the pivot and the power is applied to the second axle for power to the ground. A final drive system can use a belt, chain or driveshaft connecting via a differential gear to a solid axle. This system works best with embodiment 1: vehicle steering system rigidly mounted axle to the front frame. Should embodiment 2: vehicle steering system be used, the final drive shafts will require universal joints on the end to allow the wheels to turn independently.

Embodiment 2: Wheel motors can be used as power sources, these can attach to individual wheels on the carriage. The motors can be mounted on the second and third axles directly for final power to the ground. This solution works with either embodiments of steering.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A wheeled vehicle comprising:
a front portion including
a central support frame,
a front wheel pivotally mounted on a front end of the support frame for steering the wheeled vehicle,
a first axle mounted on a rear end of the support frame, the first axle including a first pair of wheels mounted thereon, and
a multi-axis pivot mounted on the central support frame adjacent the first axle, the multi-axis pivot including a receiver;
a rear portion having a frame portion and a second axle on a rear end thereof, wherein the second portion is secured on the multi-axis pivot of the front portion at a front end of the rear portion.

2. The wheeled vehicle of claim 1, wherein the front portion having the front wheel and first pair of wheels forms a tricycle.

3. The wheeled vehicle of claim 2, further comprising a handlebar secured to the front wheel for turning the front wheel of the vehicle to steer the vehicle.

4. The wheeled vehicle of claim 1, the rear portion comprising a pair of opposing benches for supporting a plurality of passengers on the rear portion of the wheeled vehicle.

5. The wheeled vehicle of claim 1, the pivot comprising a lower plate mounted on the support structure of the front portion, a center block pivotally attached to the lower plate along a first axis, and an upper plate mounted on the center block along a second axis.

6. The wheeled vehicle of claim 1, wherein the rear portion is affixed to the pivot of the front portion with one or more fasteners.

7. The wheeled vehicle of claim 1, wherein the rear portion is removably mounted on the pivot of the front portion.

8. The wheeled vehicle of claim 1, wherein the pivot is located on the support structure of the front portion ahead of the first axle.

9. The wheeled vehicle of claim 1, wherein the first axle is in communication with a motor for powering the wheeled vehicle.

10. A wheeled vehicle comprising:
a front portion including
a central support frame,
a front wheel pivotally mounted on a front end of the support frame for steering the wheeled vehicle,
a first axle mounted on a rear end of the support frame, the first axle including a first pair of wheels mounted thereon, and
a multi-axis pivot mounted on the central support frame adjacent to and in front of the first axle, the multi-axis pivot including a receiver;
a rear portion having a frame portion and a second axle on a rear end thereof, wherein the second portion is secured on the multi-axis pivot of the front portion at a front end of the rear portion;
wherein a weight of the rear portion supported on the front portion of the wheeled vehicle is ahead of the first axle of the wheeled vehicle.

11. The wheeled vehicle of claim 10, wherein the front portion having the front wheel and first pair of wheels forms a tricycle.

12. The wheeled vehicle of claim 11, further comprising a handlebar secured to the front wheel for turning the front wheel of the vehicle to steer the vehicle.

13. The wheeled vehicle of claim 10, the rear portion comprising a pair of opposing benches for supporting a plurality of passengers on the rear portion of the wheeled vehicle.

14. The wheeled vehicle of claim 10, the pivot comprising a lower plate mounted on the support structure of the front portion, a center block pivotally attached to the lower plate along a first axis, and an upper plate mounted on the center block along a second axis.

15. The wheeled vehicle of claim 10, wherein the rear portion is affixed to the pivot of the front portion with one or more fasteners.

16. The wheeled vehicle of claim 10, wherein the rear portion is removably mounted on the pivot of the front portion.

17. The wheeled vehicle of claim 10, wherein the first axle is in communication with a motor for powering the wheeled vehicle.

18. A wheeled vehicle comprising:
a front portion including
a central support frame,
a front wheel pivotally mounted on a front end of the support frame for steering the wheeled vehicle,
a first axle mounted on a rear end of the support frame, the first axle including a first pair of wheels mounted thereon, and
a multi-axis pivot mounted on the central support frame adjacent the first axle, the multi-axis pivot including a receiver, the multi-axis pivot having a lower plate mounted on the support structure of the front portion, a center block pivotally attached to the lower plate along a first axis, and an upper plate mounted on the center block along a second axis;
a rear portion having a frame portion and a second axle on a rear end thereof, wherein the second portion is secured on the multi-axis pivot of the front portion at a front end of the rear portion.

19. The wheeled vehicle of claim 18, wherein the pivot is located on the support structure of the front portion ahead of the first axle.

20. The wheeled vehicle of claim 10, wherein the first axle is in communication with a motor for powering the wheeled vehicle.
